(19) United States
(12) Patent Application Publication
(10) Pub. No.: US 2017/0164718 A1
(43) Pub. Date: Jun. 15, 2017

(54) COSMETIC APPLICATOR

(71) Applicant: EAST-WEST DESIGN PRIVATE LIMITED, New Delhi (IN)

(72) Inventors: Leo Clifford PIRES, Basking Ridge, NJ (US); Rahul BOSE, New Delhi (IN)

(21) Appl. No.: 15/370,696

(22) Filed: Dec. 6, 2016

(30) Foreign Application Priority Data
Dec. 10, 2015 (IN) 4034/DEL/2015

(51) Int. Cl. A45D 40/26; B29C 45/16; B29C 45/26; A45D 40/24

(52) U.S. Cl. CPC A45D 40/265; A45D 40/24; B29C 45/1625; B29C 45/2626; A45D 2200/10; B29L 2031/718

(57) ABSTRACT

A cosmetic applicator for applying a composition, the cosmetic applicator includes a molded applicator head. The applicator head comprises a molded support, at least two application elements made of a cosmetic product and wherein free ends or a portion of the at least two application elements protrudes above a level of the molded support. The support is produced by a first injection of a first material and the cosmetic product is loaded onto the support by a second injection for forming the at least two application elements. The applicator head may be used for applying cosmetic, makeup, or personal care composition to keratin materials chosen from the skin, the lips and the eyelashes, or hair of the human. The cosmetic or care product includes viscous cosmetics, powder cosmetics such as for mascara, lip stick, hair color, skin care and like products.

### CROSS-REFERENCE TO RELATED APPLICATION

This patent application claims the benefit of priority to Indian Provisional Application Ser. No. 4034/DEL/2015, filed on Dec 10, 2015. The disclosure of aforementioned patent application is incorporated by reference herein in its entirety for any purpose whatsoever.

### BACKGROUND

Field of the Invention

The subject of the present disclosure is an applicator head for a cosmetic applicator for applying cosmetic, makeup, or personal care composition to keratin materials chosen from the skin, the lips and the eyelashes, or hair of the human. The cosmetic or care product includes viscous cosmetics, powder cosmetics such as for mascara, lip stick, hair color, skin care and like products. The disclosure also relates to a method for manufacturing said applicator head.

Description of the Related Art

Application EP 1 955 610 discloses an applicator end piece which is composed exclusively of a composition for making up the eyelashes, is molded and can be mounted by being push-fitted onto a heating support in the form of a finger. However, such an end piece composed of cosmetic product mounted directly on the heating support soils this support, which has to be cleaned following each use. In addition, in order to be able to be push-fitted onto the support, the product necessarily has to extend around the entire perimeter of the applicator end piece. In addition, handling end pieces composed only of a makeup composition can lead to soiling of the user's fingers.

Application US 2007/0286831 discloses a mascara applicator comprising a heating member surmounted by a comb, in which is present in the form of bars or beads deposited on the heating member while the latter is in a housing. Feeding means comprising a piston, a cylinder or an endless screw are provided to move the product onto the heating member. The product is not directly supplied with the comb but requires a complex distributor having numerous mechanical parts, and this can hamper reliability and/or lead to the product becoming loaded with undesirable particles.

PCT Application WO 2006/043544 discloses a device for applying a cosmetic product, comprising a removable unit mounted on a receiving region of a base that faces a heating member and receives the product in the form of a block to be placed on the unit by the user and then to be melted by virtue of the heating member. However, the product is not directly supplied in a manner integrated with the unit, and the handling of the blocks can therefore lead to soiling of the user's fingers.

Document U.S. Pat. No. 5,794,632 discloses a device for applying a cosmetic product, comprising a support on which there is fixed a block of cosmetic product. However, the product is molded by being poured onto the support, this manufacturing method being well known in the field of cosmetics and requiring the separate production of the support in order to subsequently mold the product onto said support by pouring, thus resulting in a complex manufacturing process with poor output.

There is a need to develop an applicator head having a molded polymeric/metallic support with application elements molded from cosmetic product, allowing optimal utilization of the quantity of packaged cosmetic product. There is also a need for a simple, reliable process for manufacturing of such an applicator head, allowing creation of desired shapes of the application elements made from the cosmetic product.

### SUMMARY

To this end, the disclosure provides an applicator head for a cosmetic applicator for applying a cosmetic composition and a method for producing this applicator head in order to remedy the above mentioned drawbacks. The applicator head comprises a support and at least two application elements on the support, wherein the at least two application elements are injection molded on the support from a mass of cosmetic product. The support is produced by a first injection of a first material and the cosmetic product is loaded onto the support by a second injection for forming the at least two application elements.

According to an aspect of the present disclosure, the application elements protrude away from the support of the applicator head. Preferably, the application elements form raised areas of the cosmetic product on the support that can be brought into direct contact with the application area for e.g. such as eyelashes, eyebrows or skin of the user. As cosmetic product itself constitutes at least part of the application element, it will be understood that the applicator head allows for optimal utilization of the quantity of packaged cosmetic product.

According to an embodiment of the present disclosure, a cosmetic applicator is provided comprising a rod, a proximal end of the rod is connected to the closure cap while a distal end of the rod is connected to the applicator head. The closure cap may comprise engagement means such as threads for screwing for example onto a container such that the cosmetic applicator can be stored in said container. It is understood that the gripping member may have any shape suitable for gripping by the user. The applicator head may comprise suitable means for the fixing of the applicator head on the rod, for example—the fixing may be achieved by snap-fastening, push-fitting, tightly fitting or by any other means of mounting in the art. In an alternate embodiment, the rod and the support may be integrally molded as a single part.

According to an aspect of the present disclosure, the applicator head comprises a molded support and at least two protruding application elements on the molded support and wherein the at least two protruding application elements are injection molded from a mass of cosmetic product. However, in various other embodiments, in addition to the at least two protruding application elements injection molded from a mass of cosmetic product, the applicator head may comprise application elements made from material other than the cosmetic product for e.g. application elements molded from metal or plastic material, or flocking.

According to an aspect of the present disclosure, the applicator head comprises the molded core/support and a plurality of application elements projecting outwardly from the molded support. Some of the application elements are injection molded from a cosmetic product, whereas rest of the application elements are injection molded from a plastic material. The application elements injection molded from the cosmetic product are in form of discs and application elements injection molded from the plastic material are in form of tines. Preferably, the discs are arranged one after another in the longitudinal direction and are separated from one another by the molded support. The application elements can also have different types of profiles, for example rounded, triangular or in the form of a pointed arch. According to an aspect of the present disclosure, the application elements may be selected from the group consisting of conical bristles, cylindrical bristles, discs, furrows, disk segments, tooth segments, teeth, prongs, and combinations thereof.

According to another aspect of the present disclosure, the support may have a cross-section having a shape selected from a group consisting of circular, oval, non-circular and polygonal shapes.

According to another aspect of the present disclosure, the application elements injection molded from the cosmetic product are made by injection-molding cosmetic material onto the molded support such that the free ends or a portion of the application elements protrude beyond a level of the support. Such an applicator head can thus, in exemplary embodiment form an applicator of the mascara-brush type. These application elements molded from the cosmetic product allow for example a better application of the cosmetic product and also make it possible to separate and comb the eyelashes better during the application of the cosmetic product. The application elements may be mutually parallel and oriented transversely to a longitudinal axis of the applicator head. However in alternate embodiments of the present disclosure, the application elements may form an angle with the longitudinal axis of the applicator head, for example, 45°, or can even be oriented parallel to the longitudinal axis of the applicator head. It is also possible for the application elements not to be parallel to one another. The application elements may extend in at least two rows which are parallel to the longitudinal axis X of the applicator head.

The application elements molded from the cosmetic product can extend radially away from the support, however in other embodiments it is also possible for the application elements not to extend radially away from the support.

The spacing between adjacent application elements may be uniform or non-uniform.

The applicator head may extend along a longitudinal axis which may be parallel to a longitudinal axis of the rod when the applicator head is mounted on the latter. However, it is not beyond the scope of present disclosure for applicator head to make an angle with respect to the rod of the cosmetic applicator.

According to another aspect of the present disclosure, the support may comprise at least two grooves (that may or may not be connected together) and wherein each of the at least two grooves form an anchoring compartment that is able to receive a cosmetic product during injection molding to form the at least two protruding application elements and allow a better hold of the mass of cosmetic product on the support. These application elements have a height such that free ends of the application elements lie above level of the support. These application elements for example can have a height of 0.1-5.0 mm above level of the support. The application elements molded from the cosmetic product can have an identical height but can also have heights that vary from one end of the support to the other, in particular passing through a minimum half way along the support.

According to another aspect of the present disclosure, the grooves in the support extend over more than half a revolution around the central longitudinal axis X of the application head, thus the application element molded from the product forms a shell that extend over more than half a revolution around the support. In alternate embodiments, the application elements molded from the product may form a shell that extends over less than half a revolution or over less than a revolution around the support, for example so as to form a half-cylinder. In various other embodiments of the present disclosure, the grooves may be located helically around the support such that the application elements molded from the product extend helically over the support.

According to an alternate embodiment of the present disclosure, the applicator head may comprise different cosmetic products in different grooves of the support to form application elements molded of more than one product on the support. The different products are for example have different colors or have different properties. The different products proposed can for example result in makeup effects which are more or less full-bodied, and more or less lengthening. For example, the support may comprise at least two grooves each comprising a different cosmetic product. The support of the applicator head may comprise a row of grooves for anchoring a row of application elements molded from the product. A first, proximal series of application elements may comprise a first cosmetic product, for example having a first color and/or a specific threading nature. A second, distal series of application elements comprise a second cosmetic product, for example having a second color and/or a different threading nature. In this way, in the case of products to be applied to the eyelashes, the user can obtain a row of eyelashes having portions with two different colors and/or with lengthening of different lengths.

In alternate embodiments, the support may comprise two or more rows of application elements molded from the cosmetic product, each of these rows comprises a different cosmetic composition. For example, the first composition/product may be a makeup base for keratin fibers or else a composition for the cosmetic treatment of the keratin fibers, and the second composition/product may be makeup for the keratin fibers or a composition to be applied to mascara. In this way, the user can first of all apply the first product for preparing the eyelashes and then the second product for making up the eyelashes.

In a variant embodiment, the applicator head can comprise a single groove forming plurality of application elements molded from the product.

In an aspect of the present disclosure, additional application elements can be made in one piece with the rest of the support or, alternatively, be connected thereto.

The cosmetic product may be cold-applicable. For example, the product may be a makeup product such as a lipstick, a mascara, an eyeshadow or a kohl. The product may also be a body hygiene product such as a soap or a deodorant. The product may also be a hair product such as a styling gel, a wax or a haircare product. The cosmetic product P is for example an eyelash makeup composition which has a property that varies depending on the temperature, for example a threading nature.

It is for example a composition comprising at least one reversible polymer that is solid at room temperature. The term “solid” designates a product which does not flow under the effect of gravity at 20° C.

The product described in this example is of the mascara type for application to the eyelashes, but alternatively, the product may be intended for application to the lips, the nails or may otherwise be a skin makeup product, for example a foundation.

The support is, for example, made of plastics material, in particular of a polyolefin, such as polyethylene (PE) or polypropylene (PP) or, alternatively, of nonpolyolefinic materials, such as styrene/acrylonitrile (SAM), acrylonitrile/butadiene/styrene (ABS) or polyoxymethylene (POM). These plastics materials can optionally comprise, as fillers, inorganic particles or fibers, for example of metal oxides, of powder or fiber of glass or carbon black. Alternatively, the support 32 can be made of metal, for example of aluminum, brass, silver or stainless steel.

In yet another alternate embodiment, the support and application elements molded from the product may form a comb-type applicator head. The product injected may be mascara, a styling gel, a hair care product or a wax.

The support of the present disclosure is produced by injection-molding and the cosmetic product is loaded onto the support by injection-molding for forming application elements molded from the product. The method of manufacturing and loading the support with product P by injection-molding will now be described. Injection-molding is understood to be molding of a component by injecting a material in the fluid state under super-atmospheric pressure into a volume which is closed apart from the injection orifice defined by the mold.

The applicator head comprising application elements made of cosmetic product is made using a first half-mold exhibiting a first cavity and a second half-mold exhibiting a second cavity, the first cavity in combination with the second cavity defining a first injection volume for molding of the support of the applicator head, the process comprising the following stages: a first injection of a first material into the first injection volume is carried out in order to form the molded support (optionally with the application elements of first material), a second injection of cosmetic product into a second injection volume is carried out in order to form application elements, the composition of the cosmetic product being different from that of the first material forming the support. According to the disclosure, the second volume can be delimited by the first cavity, a third cavity of a third half-mold and the support which was not ejected from the first cavity, that is to say that the support remains in the first cavity, after the first injection. In this process, the injection temperature of the cosmetic product/composition can be lower than the injection temperature of the support.

The process can further comprise a third injection of a second cosmetic composition/product into a third injection volume formed of the first cavity and of a fourth cavity and comprising the support charged with first cosmetic composition which was not ejected from the first cavity after the second injection.

The injection method as described above is described in the document US20130186426. It may also be possible to inject both the cosmetic product forming application elements and the material that forms the support simultaneously or virtually simultaneously in a single mold.

According to alternate process, the applicator head of the present embodiment, as described hereinabove, is formed by a bi-injection molding process, in which a thermoplastic or thermosetting polymer and a cosmetic product such as a mascara bulk are injection-molded together to form a single article, i.e., the cosmetic applicator of the present disclosure. First, a polymer with a relatively high tensile modulus is melted and injected at high pressure into a first mold, which preferably contains two or more solid parts that are complementarily engaged with one another to define at least a first cavity therein. The first cavity corresponds to the desired shape of the elongated polymeric support to be formed with or without shape of polymeric application elements. After a cooling period sufficient to allow the molten first polymer to solidify (either completely or partially), the two or more solid parts of the first mold are disengaged from one another to expose an elongated polymeric support formed by the solidified first polymer. The elongated polymeric support so formed is then transferred into a second mold, which also contains two or more solid parts complementarily engaged with one another to define cavities that not only accommodate the elongated polymeric support already formed, but also define the desired shapes of the application elements to be formed with a cosmetic product/composition. A cosmetic composition/product, preferably already melted, can be injected at high pressure into the second mold. After the molten cosmetic composition/product cools down and solidifies (either completely or partially), the two or more solid parts of the second mold are disengaged from one another, thereby exposing multiple application elements made of the cosmetic product that have been molded over the elongated polymeric support to form the applicator head of the present disclosure.

Above mentioned methods advantageously make it possible to obtain an improved manufacturing output of applicator head, while ensuring good quality and good reproducibility of the loading with cosmetic product.

According to an aspect of the present disclosure, the cosmetic applicator may include a heating element for heating the cosmetic product on the applicator head. The applicator head may contain the same product or different products. The different products are for example having different colors or have different properties. The different products proposed can for example result in makeup effects which are more or less full-bodied, and more or less lengthening.

The cosmetic applicator can be provided to the consumer with a plurality of applicator heads. The cosmetic applicator may in particular be provided within a single packaging with a plurality of identical applicator heads or with a plurality of applicator heads holding different products and the user can then choose an applicator head depending on the product which he or she wishes to use.

The disclosure is not limited to the examples illustrated. The features of the various examples can in particular be combined as parts of variants which are not illustrated.

The expression “comprising a” should be understood as meaning “comprising at least one”, unless specified to the contrary.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a perspective view of a cosmetic applicator of the present disclosure as used within a cosmetic package;

FIG. 2A is a front view of the cosmetic applicator of FIG. 1;

FIG. 2B is an enlarged view of a portion of the cosmetic applicator of FIG. 2A;

FIG. 3 is a rear view of the cosmetic applicator of FIG. 1;

FIG. 4A is a cross-sectional view of the applicator head of the cosmetic applicator along axis A-A of FIG. 3; and

FIG. 4B is a cross-sectional view of the applicator head of the cosmetic applicator along axis B-B of FIG. 3.

To facilitate understanding, identical reference numerals have been used, where possible, to designate identical elements that are common to the figures. It is to be noted, however, that the appended drawings illustrate only typical embodiments of this disclosure and are therefore not to be considered limiting of its scope, for the disclosure may admit to other equally effective embodiments.

### DETAILED DESCRIPTION

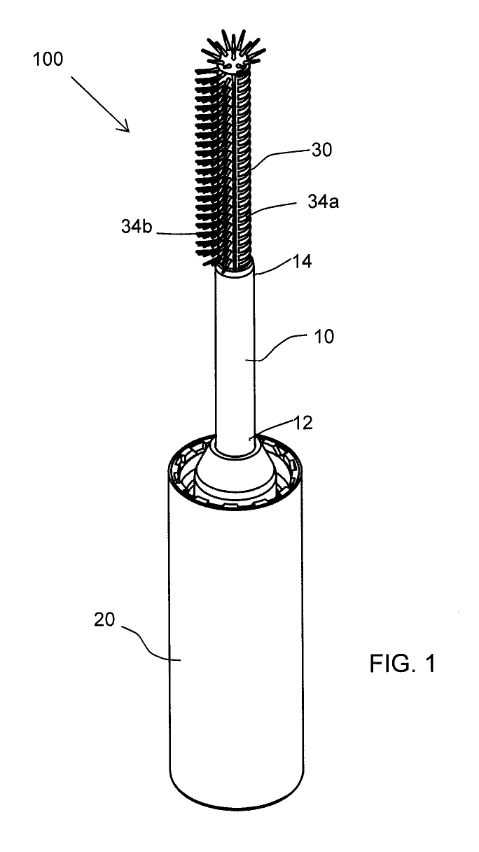

With reference to the figures, in particular to FIG. 1, a cosmetic applicator 100 according to a first implementation example comprises a rod 10, a proximal end 12 of the rod 10 is connected to the closure cap 20 while a distal end 14 of the rod 10 is connected to an applicator head 30. The closure cap 20 of the cosmetic applicator 100 comprises threads for screwing for example onto a container, not shown, such that the cosmetic applicator 100 can be stored in said container. The closure cap 20 forming a gripping member for the user and it is understood that the gripping member may have any shape suitable for gripping by the user. An applicator head 30 comprises suitable means for the fixing of the applicator head 30 on the receiving region (not shown) on the rod 10 of the cosmetic applicator 100, for example the fixing may be achieved by snap-fastening, push-fitting, tightly fitting or by any other means of mounting known in the art.

According to an aspect of the present disclosure, as shown in FIGS. 1-4B, the applicator head 30 comprises a molded support 32 and at least two protruding application elements 34a on the molded support 32, and wherein the at least two protruding application elements 34a are injection molded from a mass of cosmetic product. However, in various other embodiments, in addition to the at least two protruding application elements 34a injection molded from a mass of cosmetic product, the applicator head 30 may comprise application elements made from material other than the cosmetic product for e.g. application elements molded from metal or plastic material, or flocking. For example, as shown in an exemplary embodiment in FIGS. 1-3, the applicator head 30 comprises the molded core/support 32 and a plurality of application elements 34a and 34b projecting outwardly from the molded support 32. The application elements 34a are injection molded from a cosmetic product, whereas the application elements 34b are injection molded from a plastic material. Further, the application element 34a are in form of semicircular discs and application elements 34b are in form of tines. The semicircular discs 34a are arranged one after another in the longitudinal direction and are separated from one another by the molded support 32. According to an aspect of the present disclosure, the application elements 34a and 34b may be selected from the group consisting of conical bristles, cylindrical bristles, discs, furrows, disk segments, tooth segments, teeth, prohgs, and combinations thereof. The application elements 34a and 34b can also have different types of profiles, for example rounded, triangular or in the form of a pointed arch.

As seen in FIG. 4B, the support 32 has a circular cross-section. According to an aspect of the present disclosure, the support 32 may have a cross-section having a shape selected from a group consisting of circular, oval, non-circular and polygonal shapes.

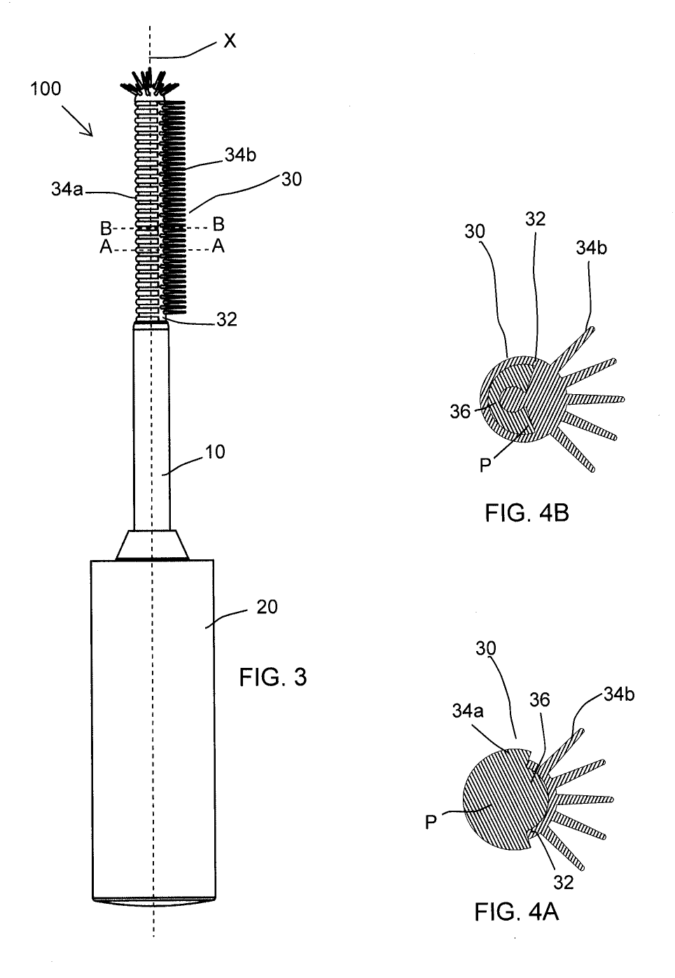

The application elements 34a are made from a cosmetic product by injection-molding it onto the molded support 32 such that the free ends or a portion of the application elements 34a protrude beyond the support 32. Such an applicator head 30 can thus, in exemplary embodiment form an applicator of the mascara-brush type. The application elements 34a allow for example a better application of the cosmetic product and also make it possible to separate and comb the eyelashes better during the application of the cosmetic product. The application elements 34a are mutually parallel and are oriented transversely to a longitudinal axis X of the applicator head 30 as illustrated in FIG. 3. However, in alternate embodiments of the present disclosure, the application elements 34a may form an angle with the longitudinal axis X, for example, 45°, or can even be oriented parallel to the axis X . It is also possible for the application elements 34a not to be parallel to one another. The application elements 34b and/or 34a may extend in at least two rows parallel to the longitudinal axis X of the applicator head 30.

The application elements 34a molded from the cosmetic product can extend radially away from the support 32, however in other embodiments it is also possible for the application elements 34a not to extend radially away from the support 32.

The spacing between adjacent application elements 34a may be uniform or non-uniform.

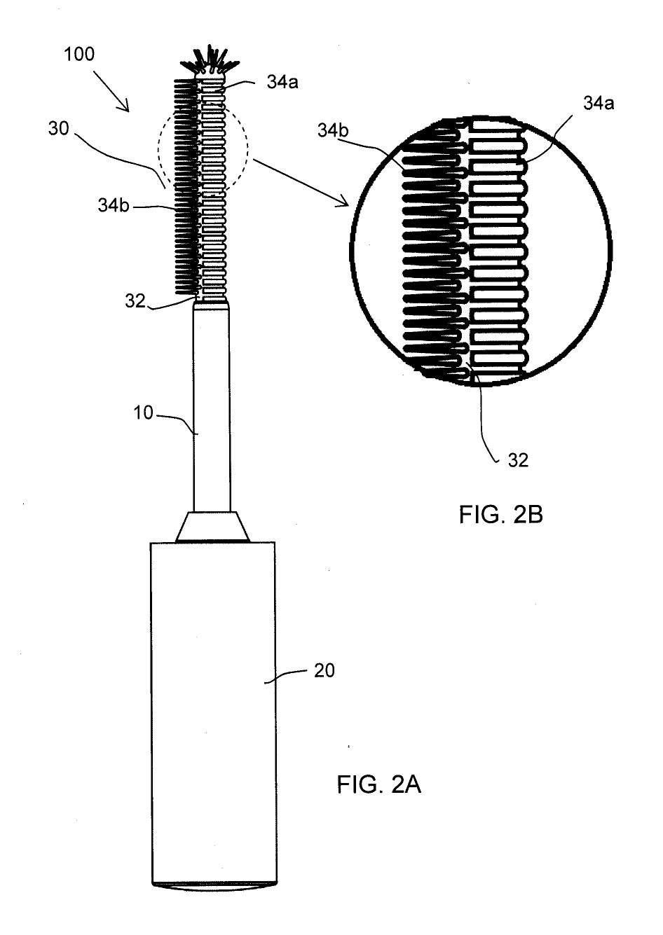

As illustrated in FIGS. 2A & 3, the applicator head 30 may extend along the longitudinal axis X, which may be parallel to a longitudinal axis of the cosmetic applicator 100 when the applicator head 30 is mounted on the latter. However, it is not beyond the scope of present disclosure for the applicator head to make an angle with respect to the rod 10 of the cosmetic applicator 100.

The support 32 may comprise at least two grooves 36 (that may or may not be connected together) and wherein each of the at least two grooves 36 form an anchoring compartment that is able to receive a cosmetic product during injection molding to form the at least two protruding application elements 34a. The cosmetic product, also called cosmetic composition, projects as application elements 34a, as illustrated in FIGS. 1-4 from the grooves 36 of the support 32. The application elements 34a for example can have a height of 0.5-3 mm above level of the support 32. The application elements 34a as illustrated have an identical height but can also have heights that vary from one end of the support to the other, in particular passing through a minimum half way along the support.

With reference to FIGS. 4A and 4B, the support 32 comprises groove/cavity 36, the cosmetic product is injected only into the groove 36. The cosmetic product is injection-molded onto the support 32, preferably, the cosmetic product is positioned in grooves 36 of the support 32 that allows for example a better hold of the mass of cosmetic product on the support 32.

As illustrated in FIGS. 4A and 4B, the grooves 36 in the support 32 extend over more than half a revolution around the central longitudinal axis X of the applicator head 30, thus the application element 34a forms a shell extending over more than half a revolution around the support 32. In alternate embodiments, the application elements 34a may form a shell that extends over less than half a revolution or over less than a revolution around the support 32, for example so as to form a half-cylinder.

In various other embodiments of the present disclosure, the grooves 36 may be located helically around the support 32 such that the application elements 34a extend helically over the support 32. The product P is injected only into these helical grooves so that the application elements 34a are formed in helical fashion on the support 32.

According to an alternate embodiment of the present disclosure, the applicator head 30 may comprise different cosmetic products in different grooves 36 to form application elements 34a of more than one product on the support 32. The different products are for example of different colors or have different properties. For example, the support 32 may comprise at least two grooves each comprising a different cosmetic product. As illustrated in FIGS. 1, 2A, 2B and 3, the support 32 of the applicator head 30 comprises a row of grooves (not shown) for anchoring application element 34a. A first, proximal series of application elements 34a may comprise a first cosmetic product, for example having a first color and/or a specific lengthening effect. A second, distal series of application elements 34a comprise a second cosmetic product, for example having a second color and/or a different lengthening effect. In this way, in the case of products to be applied to the eyelashes, the user can obtain a row of eyelashes having portions with two different colors and/or with different lengthening effects.

In alternate embodiments, the support 32 may comprise two or more rows of application elements 34a, each of these rows comprises a different cosmetic product. For example, a first product may be a makeup base for keratin fibers or else a product for the cosmetic treatment of the keratin fibers, and a second product may be makeup for the keratin fibers or a product like mascara to be applied to eyelashes. In this way, the user can first of all apply the first cosmetic product for preparing the eyelashes and then the second cosmetic product for making up the eyelashes.

A description has been given of the support 32 comprising grooves 36 forming compartments that are able to receive a cosmetic product for forming application elements 34a that project away from the support 32. However, in a variant embodiment, the applicator head 30 can comprise a single groove 36 forming plurality of application elements 34a.

The application elements 34b can be made in one piece with the rest of the support 32 or, alternatively, be connected thereto.

The cosmetic product P may be cold-applicable. For example, the product may be a makeup product such as a lipstick, mascara, an eye shadow or kohl. The product may also be a body hygiene product such as soap or a deodorant. The product may also be a hair product such as a styling gel, a wax or a hair care product. The cosmetic product P, is for example an eyelash makeup composition which has a property that varies depending on the temperature, for example a threading nature. It is for example a composition comprising at least one reversible polymer that is solid at room temperature. The term “solid” designates a product which does not flow under the effect of gravity at 20° C.

The product P described in FIGS. 1-4B, is of the mascara type for application to the eyelashes, but alternatively, the product may be intended for application to the lips, the nails or may otherwise be a skin makeup product, for example a foundation.

The support 32 is, for example, made of plastics material, in particular of a polyolefin, such as polyethylene (PE) or polypropylene (PP) or, alternatively, of nonpolyolefinic materials, such as styrene/acrylonitrile (SAM), acrylonitrile/butadiene/styrene (ABS) or polyoxymethylene (POM). These plastics materials can optionally comprise, as fillers, inorganic particles or fibers, for example of metal oxides, of powder or fiber of glass or carbon black. Alternatively, the support 32 can be made of metal, for example of aluminum, brass, silver or stainless steel.

In an alternate embodiment, the support 32 and application elements 34a may form a comb-type applicator. The product injected may be mascara, a styling gel, a hair care product or a wax.

The support 32 is produced by injection-molding and the cosmetic product is loaded onto the support 32 by injection-molding for forming application elements 34a. The method of manufacturing and loading the support 32 with cosmetic product by injection-molding will now be described. Injection-molding is understood to be molding of a component by injecting a material in the fluid state under super-atmospheric pressure into a volume which is closed apart from the injection orifice defined by the mold.

The applicator head 30 comprising application elements 34a made of cosmetic product is made using a first half-mold exhibiting a first cavity and a second half-mold exhibiting a second cavity, the first cavity in combination with the second cavity defining a first injection volume for molding the support 32 of the applicator head 30, the process comprising the following stages: (a) A first injection of a first material into the first injection volume is carried out in order to form the molded support 32 optionally with the application elements 34b. (b) A second injection of cosmetic product into a second injection volume is carried out, the composition of the cosmetic product being different from that of the first material forming the support. According to the disclosure, the second injection volume can be delimited by the first cavity, a third cavity of a third half-mold and the support which was not ejected from the first cavity, that is to say that the support 32 remains in the first cavity, after the first injection.

In this process, the injection temperature of the cosmetic composition can be lower than the injection temperature of the material of the support 32.

The process can further comprise a third injection of a second cosmetic composition into a third injection volume formed of the first cavity and of a fourth cavity and comprising the support 32 charged with first cosmetic composition which was not ejected from the first cavity after the second injection.

The injection method as described above is described in the document US20130186426. It may also be possible to inject both the cosmetic product and the material that forms the support 32 simultaneously or virtually simultaneously in a single mold.

According to alternate process, the applicator head of the present embodiment, as described hereinabove, is formed by a bi-injection molding process, in which a thermoplastic or thermosetting polymer and a cosmetic product such as a mascara bulk are injection-molded together to form a single article, i.e., the cosmetic applicator of the present disclosure. First, a polymer with a relatively high tensile modulus is melted and injected at high pressure into a first mold, which preferably contains two or more solid parts that are complementarily engaged with one another to define at least a first cavity therein. The first cavity corresponds to the desired shape of the elongated polymeric support 32 to be formed with or without shape of polymeric application elements 32b. After a cooling period sufficient to allow the molten first polymer to solidify (either completely or partially), the two or more solid parts of the first mold are disengaged from one another to expose an elongated polymeric support 32 formed by the solidified first polymer. The elongated polymeric support 32 so formed is then transferred into a second mold, which also contains two or more solid parts complementarily engaged with one another to define cavities that not only accommodate the elongated polymeric support 32 already formed, but also define the desired shapes of the application elements 34a to be formed with a cosmetic product/composition. A cosmetic composition, preferably already melted, can be injected at high pressure into the second mold. After the molten cosmetic composition cools down and solidifies (either completely or partially), the two or more solid parts of the second mold are disengaged from one another, thereby exposing multiple application elements 34a that have been molded over the elongated polymeric support 32 to form the applicator head 30 of the present disclosure.

According to an aspect of the present disclosure, the cosmetic applicator 100 may include a heating element for heating the cosmetic product on the applicator head 30. The applicator head 30 may contain the same product or different products. The different products are for example of different colors or have different properties. The different products proposed can for example result in makeup effects which are more or less full-bodied, and more or less lengthening.

The cosmetic applicator 100 can be provided to the consumer with a plurality of applicator heads 30. The cosmetic applicator 100 may in particular be provided within a single packaging with a plurality of identical applicator heads or with a plurality of applicator heads holding different products and the user can then choose an applicator head depending on the product which he or she wishes to use.

The present disclosure is not limited to the examples illustrated. The features of the various examples can in particular be combined as parts of variants which are not illustrated.

The expression “comprising a” should be understood as meaning “comprising at least one”, unless specified to the contrary.

Although the foregoing is directed to embodiments of the present disclosure, other and further embodiments of the disclosure may be devised without departing from the basic scope thereof, and the scope thereof is determined by the claims that follow. Accordingly, the appended claims should be construed to encompass not only those forms and embodiments of the disclosure specifically described above, but to such other forms and embodiments as may be devised by those skilled in the art without departing from its true spirit and scope.

What is claimed is:

1. A cosmetic applicator comprising an applicator head, the applicator head comprises:
a molded support;
at least two protruding application elements on the molded support;
wherein the at least two protruding application elements are injection molded on the molded support from a mass of a cosmetic product; and
wherein the molded support is molded from a material other than the cosmetic product.

2. A cosmetic applicator according to claim 1, wherein the cosmetic applicator includes a rod and wherein a proximal end of the rod is connected to a closure cap while a distal end of the rod is connected to the applicator head.

3. A cosmetic applicator according to claim 2, wherein the rod and the molded support are integrally molded as a single part.

4. A cosmetic applicator according to claim 1, wherein the at least two protruding application elements are selected from a group consisting of bristles, discs, furrows, disk segments, tooth segments, teeth, prongs, and combinations thereof.

5. A cosmetic applicator according to claim 1, wherein the applicator head further comprises at least one application element made from a material other than the cosmetic product.

6. A cosmetic applicator according to claim 5, wherein the at least one application element is molded from a material selected from a group consisting of metal, plastic silicon, alloy and combinations thereof.

7. A cosmetic applicator according to claim 5, wherein the at least one application element is selected from a group consisting of bristles, discs, furrows, disk segments, tooth segments, teeth, prongs, and combinations thereof.

8. A cosmetic applicator according to claim 1, wherein the at least two protruding application elements are discs that are arranged one after another in a longitudinal direction of the molded support and are separated from one another by the molded support.

9. A cosmetic applicator according to claim 1, wherein the at least two protruding applicator elements are oriented transversely to a longitudinal axis of the applicator head.

10. A cosmetic applicator according to claim 1, wherein the at least two protruding applicator elements form an angle more or less than 90 degree with a longitudinal axis of the applicator head.

11. A cosmetic applicator according to claim 1, wherein the at least two protruding applicator elements are oriented parallel to a longitudinal axis of the applicator head.

12. A cosmetic applicator according to claim 1, wherein the molded support comprises at least two grooves and wherein each of the at least two grooves form an anchoring compartment that is able to receive the cosmetic product during injection molding to form the at least two protruding application elements.

13. A cosmetic applicator according to claim 12, wherein the at least two grooves in the molded support extend more or less than half a revolution around a central longitudinal axis of the applicator head.

14. A cosmetic applicator according to claim 1, wherein the at least two application elements have a height in range of 0.1-5.0 mm above level of the molded support.

15. A cosmetic applicator according to claim 1, wherein each of the at least two application elements is molded from a different cosmetic product on the support.

16. A cosmetic applicator according to claim 1, wherein the molded support includes a single groove and wherein the single groove forms an anchoring compartment that is able to receive the cosmetic product during injection molding to form the at least two protruding application elements.

17. A cosmetic applicator according to claim 5, wherein the at least one application element is integrally molded with the molded support.

18. A cosmetic applicator according to claim 1, wherein the applicator head is formed by bi-injection molding process and wherein a thermoplastic or thermosetting polymer and the cosmetic product are injection-molded together to form the applicator head.

19. A cosmetic applicator comprising an applicator head, the applicator head comprises:
a molded support;
at least two protruding application elements on the molded support;
at least one additional application element on the molded support;
wherein the at least two protruding application elements are injection molded on the molded support from a mass of a cosmetic product; and
wherein the molded support and the at least one additional application element are molded from a material other than the cosmetic product.

20. A cosmetic applicator according to claim 19, wherein the molded support may have a cross-section having a shape selected from a group consisting of circular, oval, non-circular and polygonal shape.
